(19) United States
(12) Patent Application Publication
(10) Pub. No.: US 2025/0087685 A1
(43) Pub. Date: Mar. 13, 2025

(54) POSITIVE ELECTRODE MATERIAL, AND POSITIVE ELECTRODE PLATE AND BATTERY INCLUDING POSITIVE ELECTRODE MATERIAL

(71) Applicant: ZHUHAI COSMX BATTERY CO., LTD., Zhuhai (CN)

(72) Inventors: Kongqiang YE, Zhuhai (CN); Jiajiang ZENG, Zhuhai (CN); Suli LI, Zhuhai (CN); Heli LIU, Zhuhai (CN)

(73) Assignee: ZHUHAI COSMX BATTERY CO., LTD., Zhuhai (CN)

(21) Appl. No.: 18/923,623

(22) Filed: Oct. 22, 2024

Related U.S. Application Data
(63) Continuation-in-part of application No. PCT/CN2023/108433, filed on Jul. 20, 2023.

(30) Foreign Application Priority Data
Sep. 13, 2022 (CN) 202211112059.0

(51) Int. Cl. H01M 4/525; H01M 4/02

(52) U.S. Cl. CPC H01M 4/525; H01M 2004/021; H01M 2004/028

(57) ABSTRACT

Disclosed are a positive electrode material, and a positive electrode plate and a battery including the positive electrode material. The positive electrode material provided by the present disclosure is good in structural stability, and a battery formed by the positive electrode material has excellent cycling performance. According to the positive electrode material provided by the present disclosure, through a type and a doping amount of a doped A element, on one hand, a morphology of the positive electrode material is directionally controlled, and a press density of the positive electrode material is improved, so that an energy density of a positive plate is improved; on the other hand, an oxygen stability in the positive electrode material is improved by an A-O bond formed by the doped element A and oxygen atoms in a crystal, so that the positive electrode material has relatively high gram volume and voltage platform.

### CROSS-REFERENCE TO RELATED APPLICATIONS

The present disclosure is a continuation-in-part of International Application No. PCT/CN2023/108433, filed on Jul. 20, 2023, which claims priority to Chinese Patent Application No. 202211112059.0, filed on Sep. 13, 2022. Both of the aforementioned applications are hereby incorporated by reference in their entireties.

### TECHNICAL FIELD

The present disclosure pertains to the field of battery technologies, and specifically, to a positive electrode material, and a positive electrode plate and a battery including the positive electrode material.

### BACKGROUND

With the development and progress of lithium-ion battery technologies, higher and higher requirements have been proposed for capacities of lithium-ion batteries. In the composition of the lithium-ion batteries, capacities of positive electrode materials play a crucial role in the capacities of the lithium-ion batteries. In order to improve the capacities of the lithium-ion batteries, an important way is to improve charge/discharge voltages of the lithium-ion batteries. However, with the increasing of the voltage, the positive electrode materials encounter a series of bad changes such as unstable crystal structure, rapid capacity attenuation and greatly reduced cycling performance. Therefore, it is a very critical task to develop a positive electrode material of a lithium-ion battery with high specific capacity, high voltage platform, good cycling performance and stable interface at high voltage.

### SUMMARY

In view of the problems existing in the background, the present disclosure provides a positive electrode material, and a positive electrode plate and a battery including the positive electrode material. The positive electrode material has high specific capacity, good stable interface and cycling performance at high voltage, which may be used to improve a cycling performance, a rate performance and an energy density of the battery.

The objective of the present disclosure is implemented by using the following technical solutions.

Provided is a positive electrode material, where the positive electrode material is a lithium transition metal oxide including a Co element and an A element, and optionally including an M element, the A element includes at least one of B or P, and the M element includes at least one of Al, Mg, Ti, Mn, Te, Ni, W, Nb, Zr, La, or Y; a molar amount of the A element in per unit molar of the positive electrode is n_{A}, a molar amount of the Co element in per unit molar of the positive electrode material is n_{Co}, a molar amount of the M element in per unit molar of the positive electrode material is n_{M}, and a ratio of n_{A} to (n_{Co}+n_{M}) satisfies that: 0<n_{A}/(n_{Co}+n_{M})<0.05.

The present disclosure further provides a positive electrode plate, and the positive electrode plate includes the foregoing positive electrode material.

The present disclosure further provides a battery, and the battery includes the foregoing positive electrode material, or the battery includes the foregoing positive electrode plate.

Beneficial effects of the present disclosure are as follows.

Firstly, the positive electrode material provided by the present disclosure is good in structural stability, and a battery formed by the positive electrode material has excellent cycling performance.

Secondly, according to the positive electrode material provided by the present disclosure, through a type and a doping amount of a doped A element, on one hand, a morphology of the positive electrode material is directionally controlled, and a press density of the positive electrode material is improved, so that an energy density of a positive plate is improved; on the other hand, an oxygen stability in the positive electrode material is improved by an A-O bond formed by the doped element A and oxygen atoms in a crystal, so that the positive electrode material has relatively high capacity per gram and voltage platform.

### BRIEF DESCRIPTION OF THE DRAWINGS

FIG. 1 is a scanning electron microscope (SEM) graph of a positive electrode material in Example 1.

FIG. 2 is an SEM graph of a positive electrode material in Example 4.

FIG. 3 is an SEM graph of a positive electrode material in Example 7.

FIG. 4 is an SEM graph of a positive electrode material in Comparative Example 1.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

The present disclosure provides a positive electrode material, where the positive electrode material is a lithium transition metal oxide including a Co element and an A element, and optionally including an M element, the A element includes at least one of B or P, and the M element includes at least one of Al, Mg, Ti, Mn, Te, Ni, W, Nb, Zr, La, or Y; a molar amount of the A element in per unit molar of the positive electrode is n_{A}, a molar amount of the Co element in per unit molar of the positive electrode material is n_{Co}, a molar amount of the M element in per unit molar of the positive electrode material is n_{M}, and a ratio of n_{A} to (n_{Co}+n_{M}) satisfies that: 0<n_{A}/(n_{Co}+n_{M})<0.05.

In some examples, the “optionally” indicates that the M element may be selected or may not be selected. That is, the positive electrode material may or may not include the M element.

In some examples, the ratio of n_{A} to (n_{Co}+n_{M}) is 0.002, 0.005, 0.008, 0.010, 0.012, 0.015, 0.018, 0.020, 0.022, 0.024, 0.025, 0.026, 0.028, 0.030, 0.032, 0.034, 0.035, 0.036, 0.038, 0.04, 0.042, 0.043, 0.045, 0.046, 0.048, or 0.049.

In some examples, the molar amount n_{A} of the A element in per unit mole of the positive electrode material satisfies that: 0 mol<n_{A}<0.05 mol, for example, n_{A} is 0.001 mol, 0.002 mol, 0.003 mol, 0.004 mol, 0.005 mol, 0.006 mol, 0.007 mol, 0.008 mol, 0.010 mol, 0.012 mol, 0.015 mol, 0.018 mol, 0.020 mol, 0.022 mol, 0.024 mol, 0.025 mol, 0.026 mol, 0.028 mol, 0.030 mol, 0.032 mol, 0.034 mol, 0.035 mol, 0.036 mol, 0.038 mol, 0.04 mol, 0.042 mol, 0.043 mol, 0.045 mol, 0.046 mol, 0.048 mol, or 0.049 mol.

In some examples, the molar amount n_{A} of the A element in per unit mole of the positive electrode material satisfies that: 0.002 mol≤n_{A}≤0.45 mol.

In some examples, the molar amount n_{M} of the M element in per unit mole of the positive electrode material satisfies that: 0 mol≤n_{M}<0.1 mol, for example, n_{M} is 0 mol, 0.001 mol, 0.002 mol, 0.003 mol, 0.004 mol, 0.005 mol, 0.006 mol, 0.007 mol, 0.008 mol, 0.010 mol, 0.012 mol, 0.015 mol, 0.018 mol, 0.020 mol, 0.022 mol, 0.024 mol, 0.025 mol, 0.026 mol, 0.028 mol, 0.030 mol, 0.032 mol, 0.034 mol, 0.035 mol, 0.04 mol, 0.045 mol, 0.05 mol, 0.055 mol, 0.06 mol, 0.065 mol, 0.07 mol, 0.075 mol, 0.08 mol, 0.085 mol, 0.09 mol, or 0.095 mol.

In some examples, the molar amount n_{M} of the M element in per unit mole of the positive electrode material satisfies that: 0.0015 mol≤n_{M}≤0.03 mol.

In some examples, the positive electrode material further includes a Li element, and a molar amount n_{Li}, of the Li element in per unit mole of the positive electrode material satisfies that: 0.7 mol<n_{Li}<1 mol, for example, n_{Li}, is 0.72 mol, 0.75 mol, 0.77 mol, 0.78 mol, 0.80 mol, 0.82 mol, 0.85 mol, 0.86 mol, 0.88 mol, 0.89 mol, 0.90 mol, 0.92 mol, 0.94 mol, 0.95 mol, 0.96 mol, 0.98 mol, or 0.99 mol.

In some examples, the positive electrode material further includes a Na element, and a molar amount n_{Na} of the Na element in per unit mole of the positive electrode material satisfies that: 0 mol<n_{Na}<0.03 mol, for example, n_{Na} is 0.001 mol, 0.002 mol, 0.003 mol, 0.004 mol, 0.005 mol, 0.006 mol, 0.007 mol, 0.008 mol, 0.010 mol, 0.012 mol, 0.015 mol, 0.018 mol, 0.020 mol, 0.022 mol, 0.024 mol, 0.025 mol, 0.026 mol, or 0.028 mol.

In some examples, a chemical formula of the positive electrode material is LiₓNa_{y}Co_{1-a-b}AₐM_{b}O₂, where 0.7<x<1 (for example, is 0.71, 0.75, 0.8, 0.85, 0.9, 0.95, or 0.99), 0<y<0.03 (for example, is 0.01, 0.015, 0.02, 0.025, or 0.029), 0<a<0.05 (for example, is 0.01, 0.02, 0.03, 0.04, 0.045, or 0.049), 0≤b<0.1 (for example, is 0, 0.01, 0.02, 0.03, 0.04, 0.05, 0.06, 0.07, 0.08, 0.09, or 0.099), and 0<a/1−a<0.05 (for example, is 0.01, 0.02, 0.03, 0.04, 0.045, or 0.049), where A and M are defined as above.

In some examples, the positive electrode material has an O2 phase stacking structure and belongs to a P63mc space group.

In some examples, the positive electrode material has a polycrystalline morphology and/or a monocrystalline morphology.

In some examples, a median particle size of the positive electrode material ranges from 15 μm to 20 μm, and is, for example, 15 μm, 16 μm, 17 μm, 18 μm, 19 μm, or 20 μm.

In some examples, the A element is selected from at least one of B or P, and is preferably B. The B Element and the P element have fluxing effect, which makes a morphology of the positive electrode material be monocrystalline or polycrystalline spherical with large particle size. In particular, the B element can make a structure of the positive electrode material more stable, which can stabilize an interface between the positive electrode material and an electrolyte solution during charge and discharge, which is beneficial to improving a cycling performance of the battery. At the same time, the B Element and the P element can significantly increase a capacity per gram and a press density of the positive electrode material, which is beneficial to improve an energy density and a rate performance of the battery.

In some examples, by controlling a type and a doping amount of the A element, the morphology of the positive electrode material can be controlled; where, when the A element is the B element or both the B element and the P element, the morphology of the positive electrode material is a monocrystalline morphology; and when the A element does not include the B element, the morphology of the positive electrode material is a polycrystalline morphology.

In some examples, by controlling the type and the doping amount of the A element, the median particle size of the positive electrode material can be controlled to range from 15 μm to 20 μm, which can improve electrochemical kinetics and rate performance during charge and discharge, and reduce a polarization phenomenon, so that the battery has higher energy density, coulombic efficiency, rate performance and cycling performance.

In some examples, the positive electrode material includes but is not limited to at least one of Li_{0.72}Na_{0.02}Co_{0.958}B_{0.03}Al_{0.012}O₂, Li_{0.74}Na_{0.018}Co_{0.985}P_{0.003}Al_{0.012}O₂, Li_{0.76}Na_{0.018}Co_{0.95}B_{0.02}P_{0.004}Al_{0.026}O₂, or Li_{0.78}Na_{0.018}Co_{0.961}B_{0.02}P_{0.004}Mg_{0.015}O₂.

The present disclosure further provides a method for preparing the foregoing positive electrode material. The method includes the following steps:
(1) coprecipitating a soluble Co salt and a soluble salt optionally containing an M element to obtain a coprecipitate, and sintering the coprecipitate to obtain (Co_{1-b}M_{b})₃O₄ doped with the M element, where 0≤b<0.1;
(2) sintering a mixture of (Co_{1-b}M_{b})₃O₄, a Na source and a compound containing an A element in an air atmosphere according to a stoichiometric ratio to obtain NaₘCo_{1-a-b}AₐM_{b}, where 0.7<m<1; and
(3) mixing NaₘCo_{1-a-b}AₐM_{b} and a Li source in a mass ratio of 1:1.5 to 1:5, adding 10 times to 40 times the weight of deionized water, carrying out an ion exchange reaction at 100° C. to 200° C., and then washing and drying a reaction product to obtain the positive electrode material.

Specifically, the coprecipitating in the step (1) includes the following specific steps:
mixing the soluble Co salt and the soluble salt optionally containing the M element in a molar ratio of the Co element to the M element of (1−b):b, and adding the mixture into a solvent to obtain a mixed solution; and
adding a precipitant and a complexing agent into the mixed solution to obtain a reaction solution, adjusting a pH value of the reaction solution to range from 6 to 8, and making the reaction solution subject to a coprecipitation reaction at a predetermined temperature and a stirring rate to obtain the coprecipitate.

Further, in the step (1), the soluble Co salt includes one or more of cobalt sulfate, cobalt nitrate, cobalt chloride, or cobalt acetate; and the soluble salt containing the M element includes one or more of nitrate, sulfate, chloride, or acetate containing the M element.

Further, in the step (1), the solvent in the coprecipitating includes one or more of deionized water, methanol, or ethanol.

Further, in the step (1), the precipitant in the coprecipitating includes one or more of NaOH, KOH, Na₂CO₃, K₂CO₃, NaHCO₃, or KHCO₃. It should be noted that before adding the precipitant into the mixed solution, the precipitant may be pre-prepared to obtain a precipitant solution, and the solvent used for preparing the precipitant solution may include one or more of deionized water, methanol, or ethanol.

Further, a molar concentration of the precipitant solution ranges from 0.1 mol/L to 3 mol/L (for example, 0.1 mol/L, 0.5 mol/L, 1 mol/L, 2 mol/L, or 3 mol/L), and more preferably ranges from 1 mol/L to 3 mol/L.

Further, in the step (1), the complexing agent used in the coprecipitating includes one or more of ammonia water, ammonium carbonate, or ammonium bicarbonate. It should be noted that before adding the complexing agent into the mixed solution, the complexing agent may be pre-prepared to obtain a complexing agent solution, and the solvent used for preparing the complexing agent solution may include one or more of deionized water, methanol, or ethanol.

Further, in the step (1), a temperature of the coprecipitation reaction ranges from 25° C. to 85° C. (for example, is 25° C., 35° C., 45° C., 55° C., 65° C., 75° C., or 85° C.); and a time of the coprecipitation reaction ranges from 24 hours to 36 hours (for example, is 24 hours, 30 hours, or 36 hours).

Further, in the step (2), the Na source includes one or more of Na₂CO₃, NaOH, Na₂O, or NaCl.

Further, in the step (2), a molar ratio of the (Co_{1-b}M_{b})₃O₄ to the Na source and the compound containing the A element ranges from 0.7:(1−b−a):a to 1:(1−b−a), where 0<a<0.05, and 0≤b<0.1; and preferably, a molar ratio of Na to Co ranges from 0.72:1 to 0.76:1, for example, is 0.72:1, 0.73:1, 0.74:1, 0.75:1, or 0.76:1.

Further, in the step (2), a temperature of the sintering ranges from 750° C. to 950° C. (for example, is 750° C., 850° C., or 950° C.), and more preferably, ranges from 800° C. to 900° C.; and a time of the sintering ranges from 20 hours to 40 hours (for example, is 20 hours, 25 hours, 30 hours, 35 hours, or 40 hours), and more preferably, ranges from 24 hours to 36 hours.

Further, in the step (3), the Li source includes one or more of LiOH, LiCl, or LiNO₃.

It should be noted that in the step (3), the number of times of washing and a detergent used are not particularly limited, and only need to be selected as required, as long as a salt on a surface of a product can be removed, for example, the detergent is deionized water.

In the preparation process of the positive electrode material disclosed by the present disclosure, by comprehensively regulating and controlling types of reactants, parameters of the coprecipitation reaction, types and doping amounts of product elements and the like, the positive electrode material can have the specific chemical composition and structure disclosed by the present disclosure, which can improve an electrochemical performance of the positive electrode material greatly, and improve the cycling performance, the rate performance and the energy density of the lithium ion battery.

The present disclosure further provides a positive electrode plate, and the positive electrode plate includes the foregoing positive electrode material.

The present disclosure further provides a battery, and the battery includes the foregoing positive electrode material or the battery includes the foregoing positive electrode plate.

According to an implementation of the present disclosure, a charge cut-off voltage of the battery is greater than or equal to 4.5 V.

The present disclosure is further described in detail with reference to specific embodiments below. It should be understood that the following embodiments merely illustrate and explain an example of the present disclosure, and should not be construed as limiting the protection scope of the present disclosure. All technologies implemented based on the foregoing content of the present disclosure are within the protection scope of the present disclosure.

An experimental method used in the following embodiments is a conventional method unless otherwise stated. A reagent, a material, and the like used in the following examples may be all obtained from a commercial channel unless otherwise stated.

### Example 1

(1) Cobalt sulfate and aluminum sulfate were mixed in a molar ratio of a Co element to an Al element of 0.97:0.03, and added with deionized water to obtain a mixed solution; precipitant sodium hydroxide and complexing agent ammonia water were added into the mixed solution to obtain a reaction solution, ammonia water was introduced into the reaction solution to adjust a pH value of the reaction solution to be 7.5, and the reaction solution was subjected to a coprecipitation reaction under stirring to obtain a coprecipitate; and the coprecipitate was sintered at 700° C. to obtain (Co_{0.97}Al_{0.03})₃O₄ powder.

(2) (Co_{0.97}Al_{0.03})₃O₄, Na₂CO₃ and H₃BO₃ were mixed in a molar ratio of Co to Na and B of 0.955:0.72:0.015 to obtain mixture powder, and the mixture powder was sintered at 900° C. for 36 hours in air atmosphere to obtain Na_{0.72}Co_{0.955}B_{0.015}Al_{0.03}O₂.

(3) Na_{0.72}Co_{0.955}B_{0.015}Al_{0.03}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.9}Na_{0.02}Co_{0.955}B_{0.015}Al_{0.03}O₂.

### Example 2

(1) Same as that in Example 1.

(2) (Co_{0.97}Al_{0.03})₃O₄, Na₂CO₃ and H₃BO₃ were mixed in a molar ratio of Co to Na and B of 0.95:0.74:0.02 to obtain mixture powder, and the mixture powder was sintered at 900° C. for 36 hours in air atmosphere to obtain Na_{0.74}Co_{0.95}B_{0.02}Al_{0.03}O₂.

(3) Na_{0.74}Co_{0.95}B_{0.02}Al_{0.03}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.93}Na_{0.015}Co_{0.95}B_{0.02}Al_{0.03}O₂.

### Example 3

(1) Same as that in Example 1.

(2) (Co_{0.97}Al_{0.03})₃O₄, Na₂CO₃ and H₃BO₃ were mixed in a molar ratio of Co to Na and B of 0.945:0.76:0.025 to obtain mixture powder, and the mixture powder was sintered at 900° C. for 36 hours in air atmosphere to obtain Na_{0.76}Co_{0.945}Al_{0.03}B_{0.025}O₂.

(3) Na_{0.76}Co_{0.945}Al_{0.03}B_{0.025}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.93}Na_{0.015}Co_{0.945}B_{0.025}Al_{0.03}O₂.

### Example 4

(1) Cobalt sulfate and magnesium sulfate were mixed in a molar ratio of a Co element to a Mg element of 0.97:0.0015, and added with deionized water to obtain a mixed solution; precipitant sodium hydroxide and complexing agent ammonia water were added into the mixed solution to obtain a reaction solution, ammonia water was introduced into the reaction solution to adjust a pH value of the reaction solution to be 7.5, and the reaction solution was subjected to a coprecipitation reaction under stirring to obtain a coprecipitate; and the coprecipitate was sintered at 700° C. to obtain (Co_{0.97}Mg_{0.0015})₃O₄ powder.

(2) (Co_{0.97}Mg_{0.0015})₃O₄, NaOH and Na₄P₂O₇ were mixed in a molar ratio of Co to Na and P of 0.983:0.72:0.002 to obtain mixture powder, and the mixture powder was sintered at 900° C. for 36 hours in air atmosphere to obtain Na_{0.72}Co_{0.983}Mg_{0.0015}P_{0.002}O₂.

(3) Na_{0.72}Co_{0.983}Mg_{0.0015}P_{0.002}O₂ and LiCl were mixed in a mass ratio of 1:2.5, added with 20 times the weight of deionized water, an ion exchange reaction was carried out at 120° C., and then a reaction product was washed and dried to obtain a positive electrode material Li_{0.91}Na_{0.018}Co_{0.983}P_{0.002}Mg_{0.015}O₂.

### Example 5

(1) Same as that in Example 4.

(2) (Co_{0.97}Mg_{0.0015})₃O₄, NaOH and Na₄P₂O₇ were mixed in a molar ratio of Co to Na and P of 0.9825:0.74:0.0025 to obtain mixture powder, and the mixture powder was sintered at 900° C. for 36 hours in air atmosphere to obtain Na_{0.74}Co_{0.9825}Mg_{0.0015}P_{0.0025}O₂.

(3) Na_{0.74}Co_{0.9825}Mg_{0.0015}P_{0.0025}O₂ and LiCl were mixed in a mass ratio of 1:2.5, added with 20 times the weight of deionized water, an ion exchange reaction was carried out at 120° C., and then a reaction product was washed and dried to obtain a positive electrode material Li_{0.94}Na_{0.016}Co_{0.9825}P_{0.0025}Mg_{0.015}O₂.

### Example 6

(1) Same as that in Example 4.

(2) (Co_{0.97}Mg_{0.0015})₃O₄, NaCl and Na₄P₂O₇ were mixed in a molar ratio of Co to Na and P of 0.982:0.76:0.003 to obtain mixture powder, and the mixture powder was sintered at 900° C. for 36 hours in air atmosphere to obtain Na_{0.76}Co_{0.982}Mg_{0.0015}P_{0.003}O₂.

(3) Na_{0.76}Co_{0.982}Mg_{0.0015}P_{0.003}O₂ and LiCl were mixed in a mass ratio of 1:2.5, added with 20 times the weight of deionized water, an ion exchange reaction was carried out at 120° C., and then a reaction product was washed and dried to obtain a positive electrode material Li_{0.96}Na_{0.014}Co_{0.982}P_{0.003}Mg_{0.015}O₂.

### Example 7

(1) Cobalt sulfate and aluminum sulfate were mixed in a molar ratio of a Co element to an Al element of 0.97:0.02, and added with deionized water to obtain a mixed solution; precipitant sodium hydroxide and complexing agent ammonia water were added into the mixed solution to obtain a reaction solution, ammonia water was introduced into the reaction solution to adjust a pH value of the reaction solution to be 7.5, and the reaction solution was subjected to a coprecipitation reaction under stirring to obtain a coprecipitate; and the coprecipitate was sintered at 700° C. to obtain (Co_{0.97}Al_{0.02})₃O₄ powder.

(2) (Co_{0.97}Al_{0.02})₃O₄, NaCl, H₃BO₃ and Na₄P₂O₇ were mixed in a molar ratio of Co to Na, B and P of 0.955:0.72:0.022:0.003 to obtain mixture powder, and the mixture powder was sintered at 900° C. for 36 hours in air atmosphere to obtain Na_{0.72}Co_{0.955}B_{0.022}P_{0.003}Al_{0.02}O₂.

(3) Na_{0.72}Co_{0.955}B_{0.022}P_{0.003}Al_{0.02}O₂ and a Li source (a weight ratio of LiOH to LiNO₃ was 8:2) were mixed in a mass ratio of 1:2.5, added with 20 times the weight of deionized water, an ion exchange reaction was carried out at 120° C., and then a reaction product was washed and dried to obtain a positive electrode material Li_{0.92}Na_{0.02}Co_{0.955}B_{0.022}P_{0.003}Al_{0.02}O₂.

### Example 8

(1) Same as that in Example 7.

(2) (Co_{0.97}Al_{0.02})₃O₄, NaCl, H₃BO₃ and Na₄P₂O₇ were mixed in a molar ratio of Co to Na, B and P of 0.945:0.74:0.032:0.003 to obtain mixture powder, and the mixture powder was sintered at 900° C. for 36 hours in air atmosphere to obtain Na_{0.74}Co_{0.945}B_{0.032}P_{0.003}Al_{0.02}O₂.

(3) Na_{0.74}Co_{0.945}B_{0.032}P_{0.003}Al_{0.02}O₂ and a Li source (a weight ratio of LiOH to LiNO₃ was 8:2) were mixed in a mass ratio of 1:2.5, added with 20 times the weight of deionized water, an ion exchange reaction was carried out at 120° C., and then a reaction product was washed and dried to obtain a positive electrode material Li_{0.94}Na_{0.018}Co_{0.945}B_{0.032}P_{0.003}Al_{0.02}O₂.

### Example 9

(1) Same as that in Example 7.

(2) (Co_{0.97}Al_{0.02})₃O₄, NaCl, H₃BO₃ and Na₄P₂O₇ were mixed in a molar ratio of Co to Na, B and P of 0.935:0.76:0.04:0.005 to obtain mixture powder, and the mixture powder was sintered at 900° C. for 36 hours in air atmosphere to obtain Na_{0.76}Co_{0.935}B_{0.04}P_{0.005}Al_{0.02}O₂.

(3) Na_{0.76}Co_{0.935}B_{0.04}P_{0.005}Al_{0.02}O₂ and a Li source (a weight ratio of LiOH to LiNO₃ was 8:2) were mixed in a mass ratio of 1:2.5, added with 20 times the weight of deionized water, an ion exchange reaction was carried out at 120° C., and then a reaction product was washed and dried to obtain a positive electrode material Li_{0.96}Na_{0.016}Co_{0.935}B_{0.04}P_{0.005}Al_{0.02}O₂.

### Comparative Example 1

(1) Same as that in Example 1.

(2) (Co_{0.97}Al_{0.03})₃O₄ and Na₂CO₃ were mixed in a molar ratio of Co to Na of 0.97:0.72 to obtain mixture powder, and the mixture powder was sintered at 900° C. for 36 hours in air atmosphere to obtain Na_{0.72}Co_{0.97}Al_{0.03}O₂.

(3) Na_{0.72}Co_{0.97}Al_{0.03}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.9}Na_{0.02}Co_{0.97}Al_{0.03}O₂.

### Comparative Example 2

(1) Same as that in Example 4.

(2) (Co_{0.97}Mg_{0.0015})₃O₄ and Na₂CO₃ were mixed in a molar ratio of Co to Na of 0.985:0.72 to obtain mixture powder, and the mixture powder was sintered at 900° C. for 36 hours in air atmosphere to obtain Na_{0.72}Co_{0.985}Mg_{0.0015}O₂.

(3) Na_{0.72}Co_{0.985}Mg_{0.0015}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.91}Na_{0.018}Co_{0.985}Mg_{0.015}O₂.

### Comparative Example 3

(1) Same as that in Example 7.

(2) (Co_{0.97}Al_{0.02})₃O₄, Na₂CO₃, H₃BO₃ and Na₄P₂O₇ were mixed in a molar ratio of Co to Na, B and P of 0.91:0.72:0.05:0.02 to obtain mixture powder, and the mixture powder was sintered at 900° C. for 36 hours in air atmosphere to obtain Na_{0.72}Co_{0.91}B_{0.05}P_{0.02}Al_{0.02}O₂.

(3) Na_{0.72}Co_{0.91}B_{0.05}P_{0.02}Al_{0.02}O₂ and LiOH were mixed in a mass ratio of 1:2.5, added with 20 times the weight of deionized water, an ion exchange reaction was carried out at 120° C., and then a reaction product was washed and dried to obtain a positive electrode material Li_{0.92}Na_{0.02}Co_{0.91}B_{0.05}P_{0.02}Al_{0.02}O₂.

The positive electrode materials prepared in the above examples and comparative examples belong to a P63mc space group and have an O2 phase stacking structure. Median particle sizes of the positive electrode materials prepared in the above examples and comparative examples range from 15 μm to 20 μm.

Electrochemical performances of the positive electrode materials were studied by using CR2032 button batteries in the above examples and comparative examples, and a method for preparing the button battery was as follows.

N-methylpyrrolidone (NMP) was used as a solvent for a positive electrode plate. A positive electrode active material (the positive electrode material prepared in the examples and the comparative examples), a conductive agent Super P, and a binder polyvinylidene fluoride (PVDF) were mixed at a ratio of 97:1.5:1.5 and stirred evenly in a defoaming machine to prepare a positive electrode slurry with a solid content of 70%. The positive electrode slurry was evenly coated on a surface of an aluminum foil, baked in a vacuum oven at 100° C. for 12 hours, and then rolled and cut to obtain a positive electrode plate.

In a glove box, the positive electrode plate, a lithium-plate negative electrode, and a PP/PE/PP three-layer separator were assembled by using a 1 mol/L LiPF₆/(EC+DEC) electrolyte solution (an organic solvent was a mixture of ethylene carbonate (EC) and diethyl carbonate (DEC) in a volume ratio of 1:1) to obtain a button for electrochemical testing.

A performance test process of the button battery prepared above was as follows.

At a test temperature of 25° C., and under a voltage range of 3.0 V to 4.5 V, a rate performance was tested in the first five cycles. When charging, the voltage was charged to 4.5 V at a constant current of 0.1 C, and when discharging at a voltage of 4.5 V, discharge rates were 0.1 C, 0.2 C, 0.5 C, 1 C, and 2 C in sequence. Then, at a charge/discharge rate of 0.5 C, a 50-cycle cycling performance test was carried out at a voltage range of 3.0 V to 4.55 V. Capacity retention rate after 50 cycles (%)=discharge capacity of the 55^{th} cycle/discharge capacity of the 6^{th} cycle×100%.

TABLE 1
Rate performance test results of button batteries in Examples and Comparative Examples

| | | | Press | | | 3.0 V to |
|---|---|---|---|---|---|---|
| | | | density of | 3.0 V to 4.5 V | | 4.55 V |
| | | Morphology of | positive | Capacity per | Capacity per | Capacity |
| | | positive | electrode | gram for | gram for | retention rate |
| | Chemical formula of positive | electrode | plate | discharging at | discharging at | after 50 |
| Sample | electrode material | material | (g/cm³) | 0.1 C (mAh/g) | 1 C (mAh/g) | cycles (%) |
| Example 1 | Li_{0.9}Na0.₀₂Co_{0.955}B_{0.015}Al_{0.03}O₂ | Monocrystal | 4.15 | 200 | 198 | 91.5 |
| Example 2 | Li_{0.93}Na_{0.015}Co_{0.95}B_{0.02}Al_{0.03}O₂ | Monocrystal | 4.15 | 201 | 199 | 91 |
| Example 3 | Li_{0.93}Na_{0.015}Co_{0.945}B_{0.025}Al_{0.03}O₂ | Monocrystal | 4.15 | 201.5 | 199.5 | 91 |
| Example 4 | Li_{0.91}Na_{0.018}Co_{0.983}P_{0.002}Mg_{0.015}O₂ | Polycrystalline | 4.10 | 201 | 199.6 | 90 |
| | | spherical | | | | |
| Example 5 | Li_{0.94}Na_{0.016}Co_{0.9825}P_{0.0025}Mg_{0.015}O₂ | Polycrystalline | 4.10 | 202 | 200.6 | 90 |
| | | spherical | | | | |
| Example 6 | Li_{0.96}Na_{0.014}Co_{0.982}P_{0.003}Mg_{0.015}O₂ | Polycrystalline | 4.10 | 202.5 | 201.1 | 90.5 |
| | | spherical | | | | |
| Example 7 | Li_{0.92}Na_{0.02}Co_{0.955}B_{0.022}Po.₀₀₃Al_{0.02}O₂ | Monocrystal | 4.20 | 203 | 202 | 92 |
| Example 8 | Li_{0.94}Na_{0.018}Co_{0.945}B_{0.032}P_{0.003}Al_{0.02}O₂ | Monocrystal | 4.20 | 203.5 | 202.5 | 92.7 |
| Example 9 | Li_{0.96}Na_{0.016}Co_{0.935}B_{0.04}P_{0.005}Al_{0.02}O₂ | Monocrystal | 4.20 | 205 | 204 | 93 |
| Comparative | Li_{0.9}Na_{0.02}Co_{0.97}Al_{0.03}O₂ | Polycrystalline | 4.00 | 198 | 188.1 | 85 |
| Example 1 | | spherical | | | | |
| Comparative | Li_{0.91}Na_{0.018}Co_{0.985}Mg_{0.015}O₂ | Polycrystalline | 4.00 | 199 | 189.1 | 80 |
| Example 2 | | spherical | | | | |
| Comparative | Li_{0.92}Na_{0.02}Co_{0.91}B_{0.05}P_{0.02}Al_{0.02}O₂ | Monocrystal | 4.20 | 190 | 167.2 | 60 |
| Example 3 | | | | | | |

It may be learned from comparative analysis of the data in Table 1 that only M elements, such as Al and Mg, are doped in Comparative Examples 1 and 2, and the capacities, the rate performances and the cycling performances of Comparative Examples 1 and 2 are all worse than those in Examples 1-9 at high voltage (≥4.5 V), which indicates that the doping of B and/or P can improve the capacity per gram, the rate performance and the cycling stability of the positive electrode material. The co-doping effect of B and P is best, which indicates that B and P have a synergistic effect. In addition, the doping amounts of B and P cannot be excessive, otherwise, the capacity, the rate performance and the cycling performance of the positive electrode material are greatly reduced, because the structure of the positive electrode material is unstable after the element A is too many, resulting in an excessively large irreversible capacity and a decrease in cycling performance.

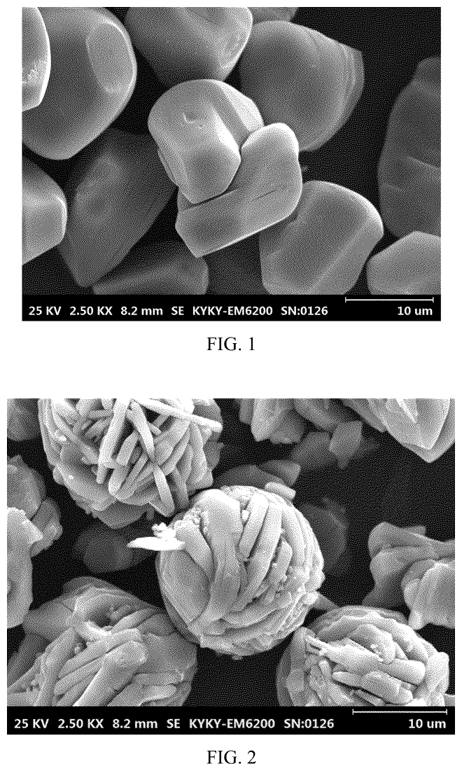

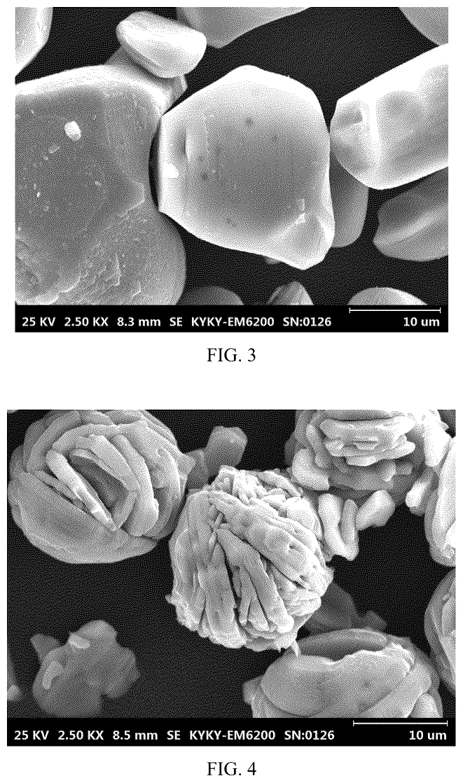

FIG. 1 is a scanning electron microscope (SEM) graph of the positive electrode material in Example 1, FIG. 2 is an SEM graph of the positive electrode material in Example 4, FIG. 3 is an SEM graph of the positive electrode material in Example 7, and FIG. 4 is an SEM graph of the positive electrode material in Comparative Example 1. It may be learned from the SEM graphs of Example 1, Example 4, Example 7 and Comparative Example 1 that, the morphology of the positive electrode material containing B doping is a monocrystalline morphology, and the positive electrode material without the B element is a polycrystalline morphology, indicating that in the sintering process, a fluxing effect of the B element has great influence on the morphology of the material, and the press density of the material after being changed from the polycrystalline morphology into the monocrystalline morphology can also be increased, so that the energy density of the lithium ion battery can be improved.

The foregoing describes the implementations of the present disclosure. However, the present disclosure is not limited to the foregoing implementations. Any modification, equivalent replacement, improvement, or the like made without departing from the spirit and the principle of the present disclosure shall fall within the protection scope of the present disclosure.

What is claimed is:

1. A positive electrode material, wherein the positive electrode material is a lithium transition metal oxide comprising a Co element and an A element, and optionally comprising an M element, the A element is selected from at least one of B or P, and the M element comprises at least one of Al, Mg, Ti, Mn, Te, Ni, W, Nb, Zr, La, or Y; a molar amount of the A element in per unit molar of the positive electrode is n_{A}, a molar amount of the Co element in per unit molar of the positive electrode material is n_{Co}, a molar amount of the M element in per unit molar of the positive electrode material is n_{M}, and a ratio of n_{A} to (n_{Co}+n_{M}) satisfies that: 0<n_{A}/(n_{Co}+n_{M})<0.05.

2. The positive electrode material according to claim 1, wherein the molar amount n_{A} of the A element in per unit mole of the positive electrode material satisfies that: 0 mol<n_{A}<0.05 mol.

3. The positive electrode material according to claim 2, wherein the molar amount n_{A} of the A element in per unit mole of the positive electrode material satisfies that: 0.002 mol≤n_{A}≤0.45 mol.

4. The positive electrode material according to claim 1, wherein the molar amount n_{M} of the M element in per unit mole of the positive electrode material satisfies that: 0 mol≤n_{M}<0.01 mol.

5. The positive electrode material according to claim 4, wherein the molar amount n_{M} of the M element in per unit mole of the positive electrode material satisfies that: 0.0015 mol≤n_{M}≤0.03 mol.

6. The positive electrode material according to claim 1, wherein the positive electrode material further comprises a Li element, and a molar amount n_{Li} of the Li element in per unit mole of the positive electrode material satisfies that: 0.7 mol<n_{Li}<1 mol.

7. The positive electrode material according to claim 1, wherein the positive electrode material further comprises a Na element, and a molar amount n_{Na} of the Na element in per unit mole of the positive electrode material satisfies that: 0 mol<n_{Na}<0.03 mol.

8. The positive electrode material according to claim 7, wherein the molar amount n_{Na} of the Na element in per unit mole of the positive electrode material satisfies that: 0.01 mol≤n_{Na}≤0.02 mol.

9. The positive electrode material according to claim 1, wherein a chemical formula of the positive electrode material is LiₓNa_{y}Co_{1-a-b}AₐM_{b}O, 0.7<x<1, 0<y<0.03, 0<a<0.05, 0≤b<0.1, and 0<a/1−a<0.05.

10. The positive electrode material according to claim 1, wherein the positive electrode material has an O2 phase stacking structure and belongs to a P63mc space group.

11. The positive electrode material according to claim 1, wherein the positive electrode material has a polycrystalline morphology and/or a monocrystalline morphology.

12. The positive electrode material according to claim 1, wherein the M element is selected from at least one of Al or Mg.

13. The positive electrode material according to claim 1, wherein a median particle size of the positive electrode material ranges from 15 μm to 20 μm.

14. The positive electrode material according to claim 1, wherein the A element is B; or the A element is P.

15. The positive electrode material according to claim 1, wherein the A element is B and P.

16. The positive electrode material according to claim 15, wherein a ratio of molar amounts of B to P ranges from 7.3:1 to 10.7:1.

17. A positive electrode plate, wherein the positive electrode plate comprises the positive electrode material according to claim 1.

18. The positive electrode plate according to claim 17, wherein a press density of the positive electrode plate ranges from 4.1 g/cm³ to 4.2 g/cm³.

19. A battery, comprising the positive electrode material according to claim 1.

20. The battery according to claim 19, wherein a charge cut-off voltage of the battery is greater than or equal to 4.5 V.
